(19) United States
(12) Patent Application Publication
(10) Pub. No.: US 2026/0138242 A1
(43) Pub. Date: May 21, 2026

(54) POWER TOOL WITH IMPULSE ASSEMBLY

(71) Applicant: MILWAUKEE ELECTRIC TOOL CORPORATION, Brookfield, WI (US)

(72) Inventors: Kentez L. Craig, Milwaukee, WI (US); Sarah K. Plunkett, New Berlin, WI (US); Troy C. Thorson, Cedarburg, WI (US)

(21) Appl. No.: 19/391,292

(22) Filed: Nov. 17, 2025

Related U.S. Application Data
(60) Provisional application No. 63/721,918, filed on Nov. 18, 2024.

(51) Int. Cl. B25B 21/02; B25B 23/00; B25B 23/18

(52) U.S. Cl. CPC B25B 21/02; B25B 23/0035; B25B 23/18

(57) ABSTRACT

A power tool may include a housing and a motor supported within the housing. A power tool may include an impulse assembly supported within the housing and configured to be driven by the motor, the impulse assembly including an anvil assembly and a hammer assembly configured to impart a torque impulse to the anvil assembly, the impulse assembly defining a hammer chamber and an anvil chamber each filled with a hydraulic fluid, wherein the hammer assembly includes: a hammer defining an inner surface and a lug protruding radially from the inner surface, and a camshaft, wherein the anvil assembly includes: an anvil defining a passageway communicating between the hammer chamber and the anvil chamber, and a blade coupled to the anvil and configured to impact the lug, wherein the camshaft is configured to selectively open and close the passageway.

### CROSS-REFERENCE TO RELATED APPLICATIONS

The present application claims priority to U.S. Provisional Ser. No. 63/721,918, filed Nov. 18, 2024, the entire content of which is incorporated herein by reference.

### FIELD

The present disclosure relates to power tools, and more particularly, to hydraulic impulse power tools.

### BACKGROUND

Impulse power tools can deliver torque impulses to a workpiece at high speeds by accumulating energy in a rotating mass and transmitting the energy to an output shaft. The output shaft may be capable of holding a tool bit or engaging a socket. Impulse tools typically utilize percussive transfers of high momentum, which is transmitted through the output shaft using a variety of means, such as electric or electromagnetic mechanisms, oil-pulse mechanisms, mechanical-pulse mechanisms, or any suitable combination thereof.

### SUMMARY

In some aspects, the techniques described herein relate to a power tool configured to deliver torque impulses to a tool bit, the power tool including: a housing; a motor supported within the housing; and an impulse assembly supported within the housing and configured to be driven by the motor, the impulse assembly including an anvil assembly and a hammer assembly configured to impart a torque impulse to the anvil assembly, the impulse assembly defining a hammer chamber and an anvil chamber each filled with a hydraulic fluid; wherein the hammer assembly includes: a hammer defining an inner surface and a lug protruding radially from the inner surface, and a camshaft; wherein the anvil assembly includes: an anvil defining a passageway communicating between the hammer chamber and the anvil chamber, and a blade coupled to the anvil and configured to impact the lug; wherein the camshaft is configured to selectively open and close the passageway; and wherein the camshaft defines a key, and the hammer defines a key receptacle that receives the key to rotationally couple the camshaft to the hammer.

In some aspects, the techniques described herein relate to a power tool, wherein the camshaft further includes a tab axially captured between the anvil and the hammer.

In some aspects, the techniques described herein relate to a power tool, wherein the hammer defines an outer diameter, and a ratio of a rotational inertia of the hammer assembly to the outer diameter of the hammer when the motor operates at a maximum speed is between 1.0 and 2.0.

In some aspects, the techniques described herein relate to a power tool, wherein the hammer assembly further includes an end cap coupled to the hammer, and wherein the power tool further includes a wiper seal positioned between the end cap and the anvil to seal the hydraulic fluid.

In some aspects, the techniques described herein relate to a power tool, further including: a case defining a bearing pocket; and a bearing having an inner race supporting the anvil and an outer race received into the bearing pocket, the outer race including a cylindrical outer wall and a flange protruding radially from the cylindrical outer wall.

In some aspects, the techniques described herein relate to a power tool, wherein the bearing pocket includes a cylindrical bore and a counterbore, and wherein the cylindrical outer wall is received in the cylindrical bore, and the flange is at least partially received in the counterbore.

In some aspects, the techniques described herein relate to a power tool, wherein an axial length of the outer race is equal to or greater than an axial length of the bearing pocket.

In some aspects, the techniques described herein relate to an impulse assembly for a power tool, the impulse assembly including: a hammer assembly including a hammer and a camshaft coupled to the hammer, the hammer defining an inner surface and a lug protruding radially inward from the inner surface, and an anvil assembly including an anvil and a blade positioned to impact the lug during rotation of the hammer; wherein the impulse assembly defines a hammer chamber and an anvil chamber each filled with hydraulic fluid; wherein the anvil defines a first passageway and a second passageway communicating between the hammer chamber and the anvil chamber; wherein the camshaft is configured to selectively open and close the second passageway; and wherein the camshaft includes a tab axially captured between the anvil and the hammer.

In some aspects, the techniques described herein relate to an impulse assembly, wherein the anvil includes a set screw configured to adjust a cross-sectional area of the first passageway.

In some aspects, the techniques described herein relate to an impulse assembly, further including a bladder positioned within the hammer assembly and configured to modulate pressure of the hydraulic fluid.

In some aspects, the techniques described herein relate to an impulse assembly, further including a friction plate positioned adjacent the bladder and defining notches communicating with the hammer chamber.

In some aspects, the techniques described herein relate to an impulse assembly, wherein the camshaft includes lobes and flats alternating about a circumference of the camshaft to selectively open and close the second passageway.

In some aspects, the techniques described herein relate to an impulse assembly, wherein the tab is captured between a rear wall of the hammer and a shaft segment of the anvil.

In some aspects, the techniques described herein relate to an impulse assembly, wherein the camshaft defines a key, and the hammer defines a key receptacle that receives the key to rotationally couple the camshaft to the hammer.

In some aspects, the techniques described herein relate to a power tool including: a housing; a motor supported within the housing; an output assembly configured to be driven by the motor, the output assembly including an output shaft and a tool holder configured to support a tool bit; a case defining a bearing pocket including a cylindrical bore and a counterbore; and a bearing having an inner race supporting the output shaft and an outer race received into the bearing pocket, the outer race including a cylindrical outer wall and a flange protruding radially from the cylindrical outer wall; wherein the cylindrical outer wall is received in the cylindrical bore, and the flange is at least partially received in the counterbore.

In some aspects, the techniques described herein relate to a power tool, wherein the flange abuts a stop surface of the counterbore.

In some aspects, the techniques described herein relate to a power tool, wherein the outer race has an axial length equal to or greater than an axial length of the bearing pocket.

In some aspects, the techniques described herein relate to a power tool, wherein the bearing is insert molded into a molded case and includes two flanges and a circumferential groove between the two flanges.

In some aspects, the techniques described herein relate to a power tool, wherein the output assembly further includes: a hammer assembly including a hammer and a camshaft coupled to the hammer, the hammer defining an inner surface and a lug protruding radially inward from the inner surface; and an anvil assembly including an anvil and a blade positioned to impact the lug during rotation of the hammer; wherein the camshaft defines a key, and the hammer defines a key receptacle that receives the key to rotationally couple the camshaft to the hammer.

In some aspects, the techniques described herein relate to a power tool, wherein the hammer defines an outer diameter, and a ratio of a rotational inertia of the hammer assembly to the outer diameter of the hammer when the motor operates at a maximum speed is between 1.0 and 2.0.

### BRIEF DESCRIPTION OF THE DRAWINGS

FIG. 1 is a perspective view of a power tool according to an embodiment of the present disclosure.

FIG. 2 is a side view showing the power tool of FIG. 1 with portions removed.

FIG. 3 is a cross-sectional view of the power tool of FIG. 1, taken along line 3-3 of FIG. 1.

FIG. 4 is a perspective view of a drive assembly of the power tool of FIG. 1.

FIG. 5 is a partially exploded perspective view of the drive assembly of FIG. 4.

FIGS. 6A and 6B are perspective views of an impulse assembly of the power tool of FIG. 1.

FIG. 7 is a partially exploded perspective view of the impulse assembly of FIG. 6A.

FIG. 8A is a partially exploded partial perspective view of the power tool of FIG. 1, showing a front bearing with a flange.

FIG. 8B is a detailed view showing portions of the cross-sectional view of FIG. 3.

FIG. 8C is a detailed view showing portions of the cross-sectional view of FIG. 3 according to an alternative embodiment.

FIG. 9 is a cross-sectional view of the impulse assembly of FIG. 6A, taken along line 9-9 of FIG. 6A.

FIG. 10 is a cross-sectional view of the impulse assembly of FIG. 6A, taken along line 10-10 of FIG. 6A.

FIG. 11A is a cross-sectional view of the impulse assembly of FIG. 6A, taken along line 11A-11A of FIG. 6A and illustrating a hammer assembly oriented at a starting position relative to the anvil assembly.

FIG. 11B is a detailed cross-sectional view showing portions of the impulse assembly of FIG. 6A, taken along line 10-10 of FIG. 6A and showing the hammer assembly of FIG. 11A oriented at the starting position.

FIG. 12 is a partially exploded partial perspective view showing the hammer assembly and the anvil assembly with portions removed.

FIG. 13 is a partially exploded partial perspective view showing the hammer assembly and the anvil assembly with portions removed.

FIG. 14A is a cross-sectional view of the impulse assembly of FIG. 6A, taken along line 11A-11A of FIG. 6A and illustrating the hammer assembly of FIG. 11A oriented a initial impact position relative to the anvil assembly.

FIG. 14B is a detailed cross-sectional view showing portions of the impulse assembly of FIG. 6A, taken along line 10-10 of FIG. 6A and showing the hammer assembly of FIG. 11A oriented at the initial impact position.

FIG. 15A is a cross-sectional view of the impulse assembly of FIG. 6A, taken along line 11A-11A of FIG. 6A and illustrating the hammer assembly of FIG. 11A oriented an intermediate impact position relative to the anvil assembly.

FIG. 15B is a detailed cross-sectional view showing portions of the impulse assembly of FIG. 6A, taken along line 10-10 of FIG. 6A and showing the hammer assembly of FIG. 11A oriented at the intermediate impact position.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

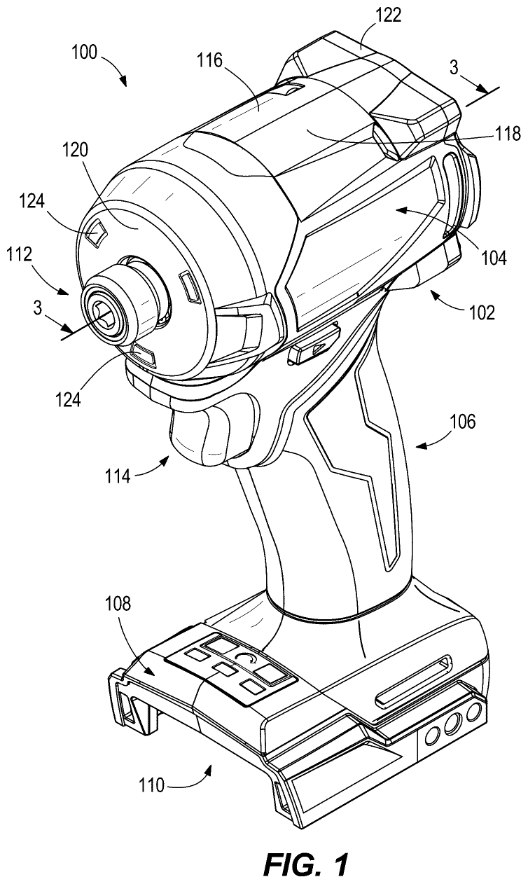

FIG. 1 illustrates a power tool embodied as an impulse driver 100. The impulse driver 100 includes a housing 102 having a motor housing portion 104, a handle portion 106, and a foot portion 108. The foot portion 108 includes a battery receptacle 110 that selectively and removably couples to a battery pack (not shown) to power the impulse driver 100. The impulse driver 100 also includes tool holder 112 which removably receives an output tool (e.g., a driver bit; not shown). The impulse driver 100 further includes a trigger 114 that, when actuated, causes the tool holder 112 to rotate (e.g., to perform a fastening operation).

In the embodiment shown in FIG. 1, the housing 102 includes a first clamshell half 116, a second clamshell half 118, a front cover 120, and a rear cover 122. The front cover 120 supports a plurality of light fixtures 124 (e.g., LED light fixtures) which are operable to light a workspace upon actuation of the trigger 114.

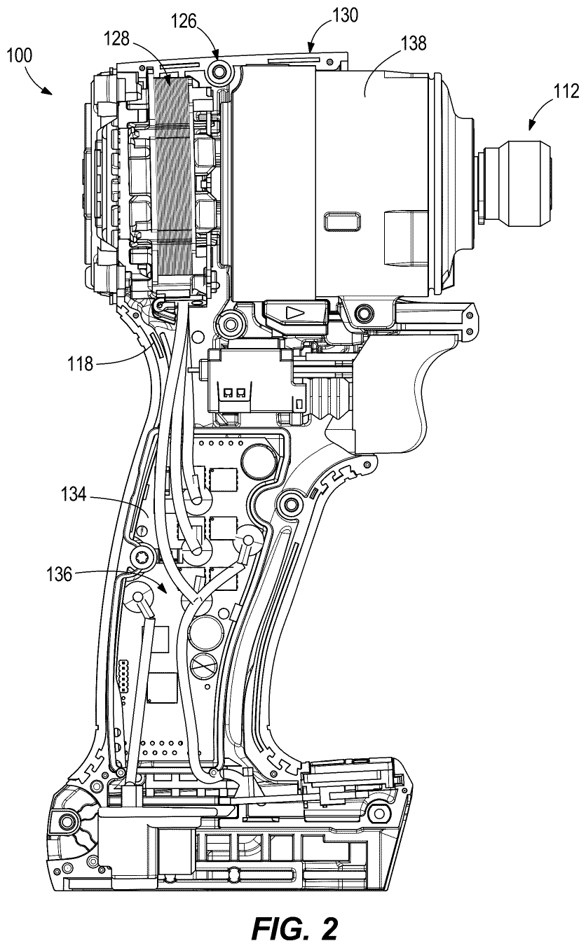

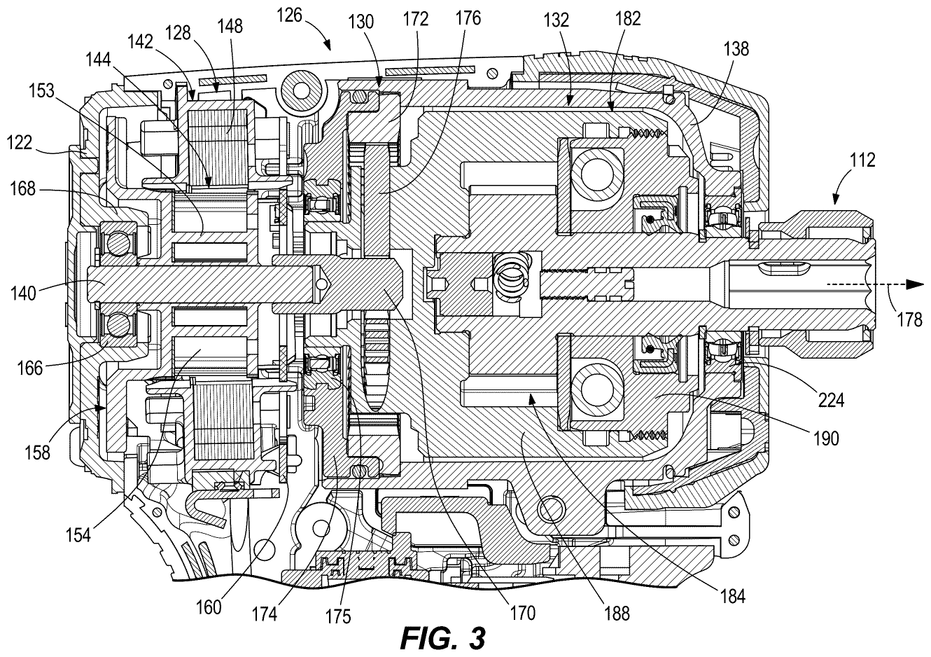

FIG. 2 illustrates the impulse driver 100 with the first clamshell half 116, the front cover 120, and the rear cover 122 removed. The impulse driver 100 includes a drive assembly 126 operable to impart torque to the tool holder 112. The drive assembly 126 includes an electric motor 128, a transmission 130, and an output assembly in the form of an impulse assembly 132 (FIG. 3). The impulse driver 100 also includes a printed circuit board assembly 134 (PCBA 134) which supports a controller 136. The controller 136 is operable to control multiple aspects of the impulse driver 100, such as operation of the electric motor 128 and the plurality of light fixtures 124. For example, the controller 136 is operable to deliver electric current to the electric motor 128 to cause the electric motor 128 to start, accelerate, decelerate, or stop. The impulse driver 100 also includes an annular case 138 positioned adjacent the front cover 120 and between the clamshell halves 116, 118. The annular case 138 supports the transmission 130 and at least partially supports the electric motor 128. The annular case 138 also rotatably supports the impulse assembly 132.

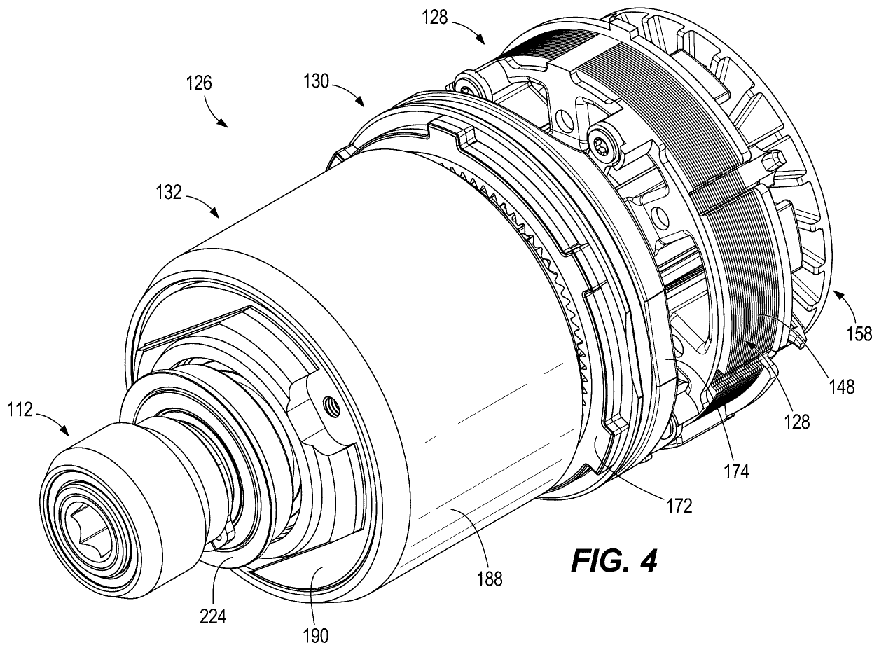

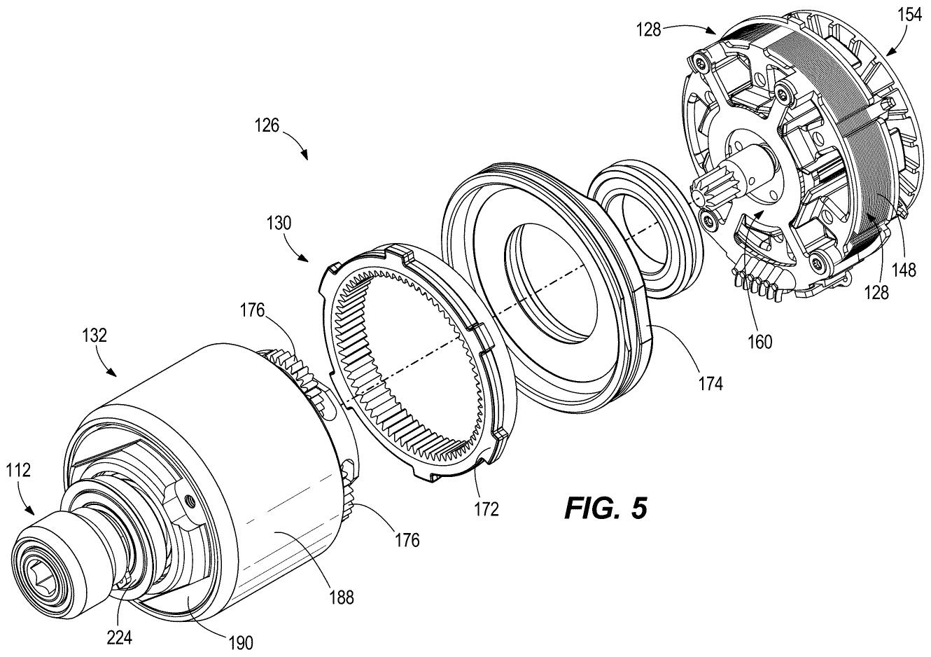

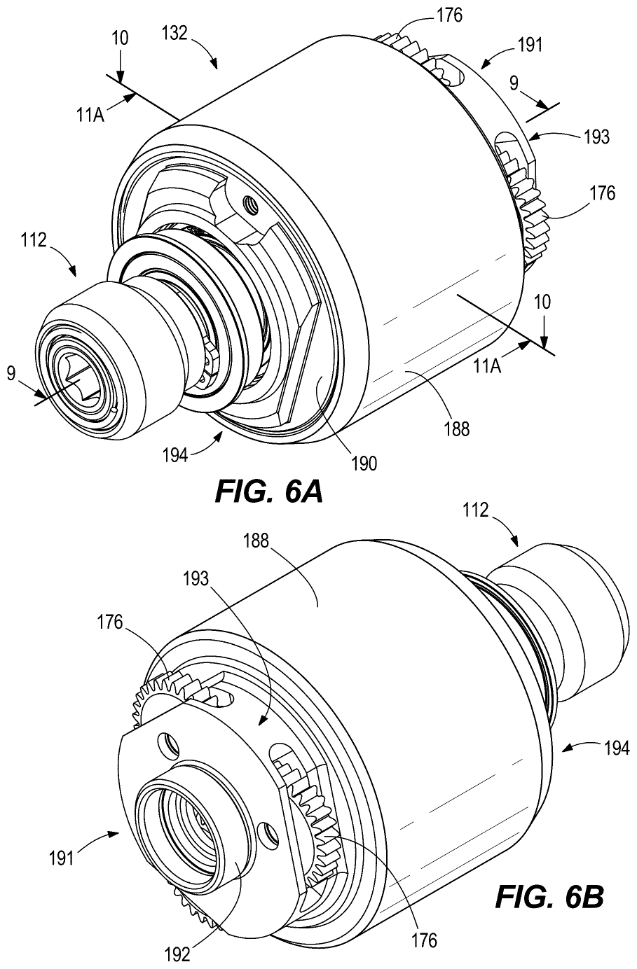

With reference to FIGS. 3-6B, the electric motor 128 is a brushless, direct-current electric motor 128 having a motor shaft 140, a stator 142, and a rotor 144 affixed to the motor shaft 140 for co-rotation therewith. The stator 142 surrounds the rotor 144. The stator 142 includes a stator core 148 supported by the housing 102 and a plurality of coils (not shown) supported on the stator core 148. The rotor 144 includes a rotor body 153 supporting a plurality of permanent magnets 154. The rotor body 153 is coupled to a fan 158 which generates a cooling airflow within the housing 102. The electric motor 128 further includes a sensor board 160 which is operable to detect a rotational position of the rotor 144 and communicate a position signal to the controller 136 (FIG. 2).

With continued reference to FIGS. 3-5, the electric motor 128 includes a motor bearing 166 positioned at a rear distal end of the motor shaft 140. The motor bearing 166 is supported about its outer race by a rear bearing support 168 which is defined by the rear cover 122. The electric motor 128 further includes an output gear 170 (e.g., a pinion), which engages the transmission 130.

The transmission 130 includes a ring gear 172 and planetary gears 176 which are supported by the impulse assembly 132. The ring gear 172 is fixedly secured to the case 138 via, e.g., press fit. The ring gear 172 is also fixedly secured to a central bearing mount 174. The central bearing mount 174 supports a central bearing 175, which rotatably supports the impulse assembly 132 for rotation about an output axis 178. The planetary gears 176 mesh with the output gear 170 and with the ring gear 172. The transmission 130 effects a rotational speed reduction from the motor shaft 140 to the impulse assembly 132 and a corresponding torque increase therebetween.

With continued reference to FIGS. 3-6B, the impulse assembly 132 includes a hammer assembly 182 and an anvil assembly 184. The hammer assembly 182 is rotatably supported within the case 138 about the anvil assembly 184 and by the central bearing 175. In the illustrated embodiment, the impulse assembly 132 is an oil impulse assembly which utilizes an incompressible fluid, such as hydraulic fluid, such as oil or the like, to effect and modulate torque impulses delivered from the hammer assembly 182 to the anvil assembly 184, as will be explained herein.

When the electric motor 128 is activated, torque is transmitted from the motor shaft 140 to the hammer assembly 182, causing the hammer assembly 182 to rotate about the output axis 178 relative to the case 138. The hammer assembly 182 includes a hammer 188 and an end cap 190 secured to the hammer 188. A rear end 191 of the hammer 188 defines an annular tail 192 which is supported by an inner race of the central bearing 175. The rear end 191 also defines planetary carrier 193 which supports the planetary gears 176. A front end 194 of the hammer 188, which is located opposite from the rear end 191 along the output axis 178, is secured to the end cap 190. Specifically, the hammer 188 is drum-shaped and includes an annular side wall 196 and a closed rear wall 198 which is located toward the rear end 191. The side wall 196 defines an opening 200 at the front end 194 and is internally threaded adjacent the opening 200. The end cap 190 is ring-shaped and is externally threaded so that it threadably tightens into the hammer 188 through the opening 200.

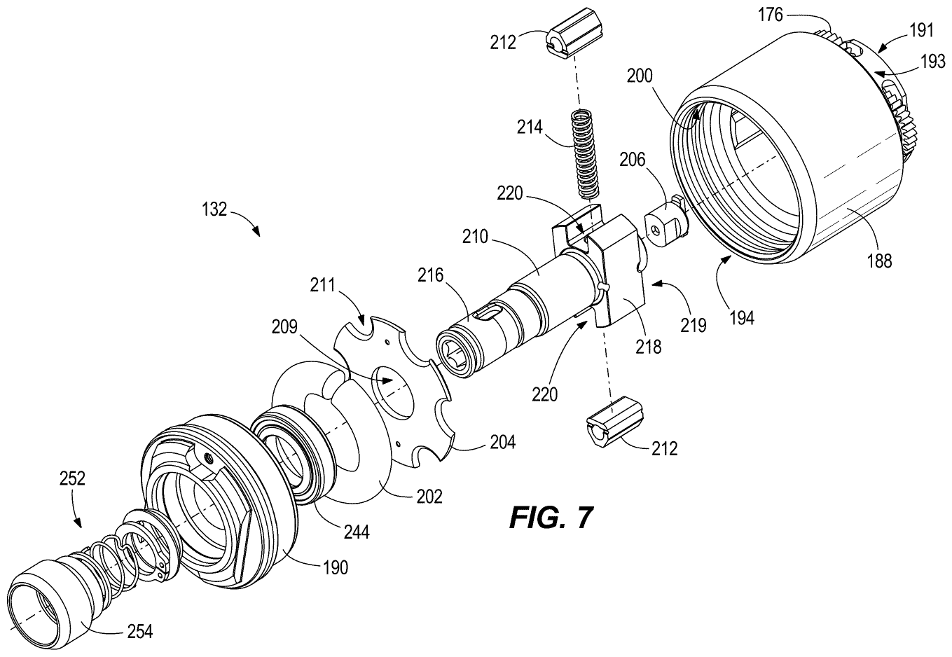

With reference to FIGS. 7, 9, and 10, the hammer assembly 182 also includes a bladder 202, a friction plate 204, and a camshaft 206. The bladder 202 is annular or ring-shaped and formed from a flexible material that encloses an internal space which is filled with a compressible fluid. The end cap 190 defines an annular recess 207 which houses the bladder

The friction plate 204 is also annular and disk-shaped and defines an internal aperture 209 at its inner perimeter and a plurality of notches 211 at its outer perimeter. The friction plate 204 is captured between the end cap 190 and the hammer 188 and partially covers the annular recess 207 and the bladder 202. The notches 211 communicate the annular recess 207 with an interior of the hammer 188. As such, changes in a pressure of the hydraulic fluid during operation of the impulse assembly 132 are communicated to the bladder 202, which expands or contracts in response to the pressure changes to thereby modulate the pressure.

The hammer assembly 182 has a high rotational inertia for its size, compared to known impulse tools. For example, in some embodiments, a first ratio R1, defined as a ratio of the rotational inertia of the hammer assembly 182 to an outer diameter of the hammer 188 when the motor 128 operates at its maximum speed, may be greater than 0.8, greater than 1.0, greater than 1.2, greater than 1.4, or greater than 1.6. In some embodiments, the first ratio R1 may be between 1.0 and 2.0. In the illustrated embodiment, the first ratio R1 is about 1.8. The relatively high rotational inertia of the hammer assembly 182 is provided by a relatively high density and mass, combined with a relatively high maximum rotational speed compared to known impulse tools. This advantageously provides the impulse driver 100 with improved performance (e.g., increased fastening speeds and/or fastening torque) compared to known impulse tools.

With reference to FIGS. 7, 9, and 10, the anvil assembly 184 includes an anvil 210, a pair of blades 212, and a spring 214. The anvil 210 is elongated and includes an output shaft 216 and a block 218 integrally defined at a rear end 219 of the output shaft 216. The block 218 defines a pair of slots 220 located on opposite lateral sides of the block 218. The anvil 210 also defines a transverse bore 222 that extends internally communicates between both slots 220. The blades 212 are received into the longitudinal slots 220. The spring 214 resides in the transverse bore 222 and engages both blades 212 at its respective ends. The spring 214 biases the blades 212 radially outward, i.e., out of the slots 220 in the radial direction.

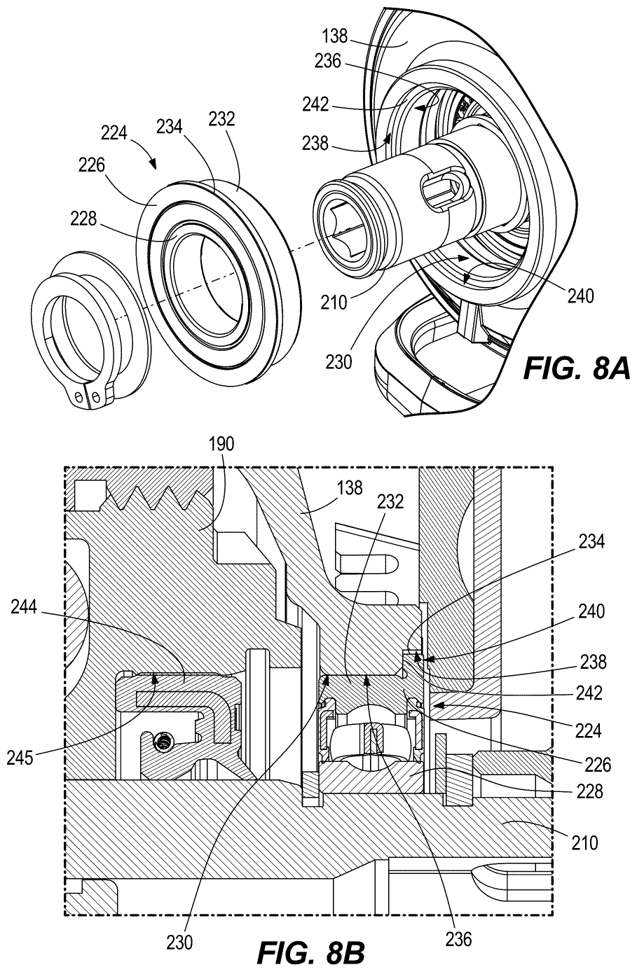

With reference to FIGS. 8A and 8B, the impulse driver 100 also includes a front bearing 224 which rotatably supports the anvil 210. The front bearing 224 includes an outer race 226 and an inner race 228. The case 138 defines a front bearing pocket 230 which receives and holds the outer race 226 of the front bearing 224. The inner race 228 receives and rotatably supports the anvil 210. The front bearing 224 is a flanged bearing, such that the outer race 226 includes a cylindrical outer wall 232 and a flange 234 protruding radially outward from the cylindrical outer wall 232 at one end of the outer race 226. The bearing pocket 230 is defined by a cylindrical bore 236 and a counterbore 238 located axially outward from the cylindrical bore 236 and extending from the cylindrical bore 236 to a front opening 240 of the case 138. The counterbore 238 is partially defined by an axially facing stop surface 242. When the front bearing 224 is inserted into the front bearing pocket 230 (e.g., via a pressing operation), the cylindrical outer wall 232 is received into the cylindrical bore 236 (e.g., by interference fit or press fit) and the flange 234 is received into the counterbore 238. The flange 234 abuts the stop surface 242, which limits an axial position of the front bearing 224. The flange 234 is also received entirely or almost entirely into the counterbore 238, such that a front face of the flange 234 is coplanar or nearly coplanar with the front opening 240. This flanged configuration of the front bearing 224 differs from traditional front bearing arrangements in existing rotary impact tools (not shown), which typically include a retaining wall of the case which extends axially beyond the front bearing to abut the outer race. In contrast with such prior art designs, the flanged configuration of the front bearing pocket 230 permits such a retaining wall to be omitted from the case 138 while maintaining a sufficiently large size of the front bearing 224 to withstand the forces associated with operation of the impulse driver 100. In this arrangement, the bearing 224, and more specifically, the outer race 226, has an axial length that is equal to, or not less than, an axial length of the front bearing pocket 230. As such, the axial length of the front bearing pocket 230 is minimized relative to the axial length of the bearing 224. A length of the case 138 can therefore be reduced by a length of the omitted retaining wall, which results in an overall shortening of the axial length of the impulse driver 100.

With reference to FIG. 8C, in an alternative embodiment, the impulse driver 100 includes a front bearing 224A rotatably supporting the anvil 210. The front bearing 224A includes an inner race 228A like the inner race 228 of the front bearing 224, but the front bearing 224A includes an outer race 226A which differs from the outer race 226. The front bearing 224A is insert molded into a molded case 138A, or more specifically, into a front bearing pocket 230A of the molded case 138A. Insert molding the front bearing 224A to the case 138A allows for alternative geometries at an interface between the outer race 226A and the front bearing pocket 230A which aren't possible for a press-fit arrangement like that of the front bearing 224 of FIG. 8B. In the embodiment of FIG. 8C, the outer race 226A includes two flanges 234A, with one of the flanges 234A located at each axial end thereof. A circumferential groove 229A is defined between the flanges 234A. The front bearing pocket 230A of the molded case 138A includes an inner circumferential rib 239A that is received into the circumferential groove 229A. Each flange 234A is received entirely or nearly completely within a corresponding counterbore 238A formed on each axial side of the inner circumferential rib 239A. As such, the bearing 224A, and more specifically, the outer race 226A, has an axial length that is equal to, or not less than, an axial length of the front bearing pocket 230A. The axial length of the front bearing pocket 230A is therefore minimized and allows for a shortened overall axial length of the impulse driver 100.

With reference to FIG. 8B, the impulse driver 100 also includes a wiper seal 244 positioned between the end cap 190 and the anvil 210. The end cap 190 defines a front recess 245 which receives and holds the wiper seal 244 (e.g., via press fit). The wiper seal 244 seals the hydraulic fluid within the impulse assembly 132.

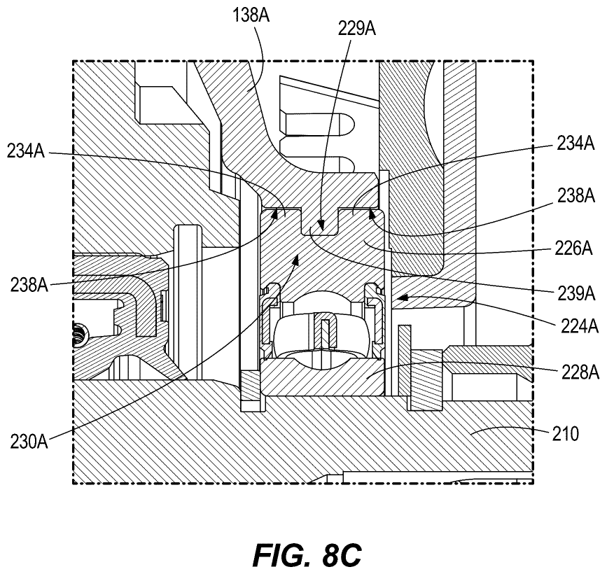

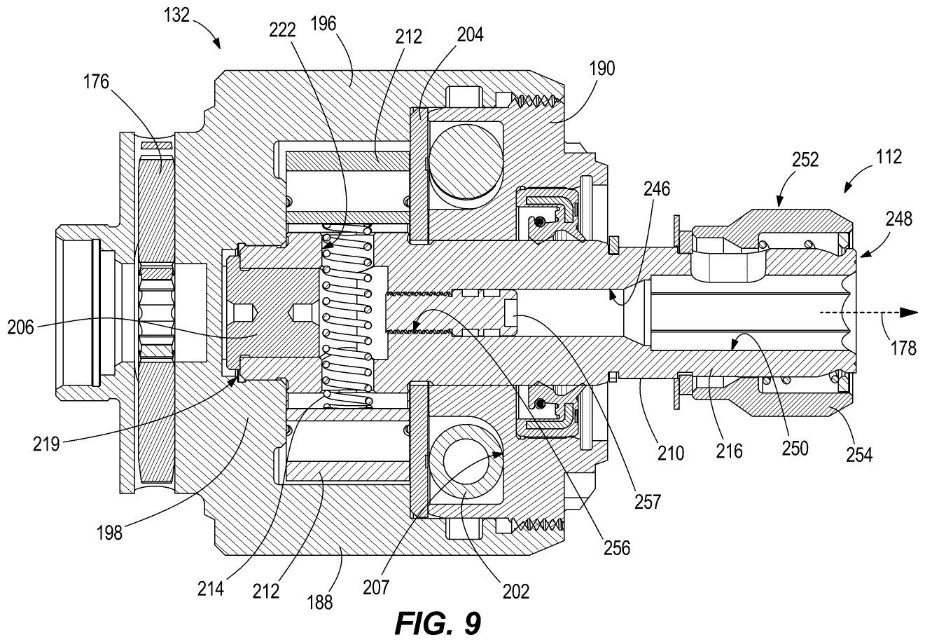

With reference to FIGS. 9 and 10, the anvil 210 defines an axial through bore 246 which extends from the rear end 219 to an output end 248, i.e., a front end thereof. The axial through bore 246 intersects the transverse bore 222. The output end 248 includes a hexagonal region 250 of the axial through bore 246, which receives a corresponding hexagonally-shaped portion of the driver bit (not shown). The tool holder 112 includes the output shaft 216, with the hexagonal region 250, and a bit retainer 252. The bit retainer 252 includes a sleeve 254 which is biased toward a lock position at which the driver bit is held or retained within the hexagonal region 250. The sleeve 254 is slidable and can be moved to a release position at which the driver bit may be removed from the hexagonal region 250.

The axial through bore 246 receives a portion of the camshaft 206 at the rear end 219 of the anvil 210. The anvil 210 also defines an internally threaded surface 256 located between the hexagonal region 250 and the transverse bore 222. The anvil assembly 184 further includes a set screw 257 which tightens into the internally threaded surface 256.

With continued reference to FIGS. 9 and 10, the impulse assembly 132 defines a hammer chamber 258 between the hammer 188, the anvil assembly 184, and the end cap 190. The hammer chamber 258 is filled with the hydraulic fluid. The impulse assembly 132 also defines an anvil chamber 260. The anvil chamber 260 is defined within the axial through bore 246 between the camshaft 206 and the set screw 257, within the transverse bore 222 and between the slots 220, the blades 212, the closed rear wall 198, and the friction plate 204. The anvil chamber 260 is also filled with the hydraulic fluid.

With reference to FIG. 10, the anvil 210 also defines a first passageway 262, or a restricted flow passageway, which communicates between the hammer chamber 258 and the anvil chamber 260. The hydraulic fluid can flow between the hammer chamber 258 and the anvil chamber 260 via the first passageway 262. The first passageway 262 also communicates with the axial through bore 246 and is located adjacent the internally threaded surface 256. As shown in FIG. 10, the set screw 257 can partially protrude into the first passageway 262 to thereby constrict or reduce a cross-sectional area of the first passageway 262. The set screw 257 can be adjusted (by rotating clockwise or counterclockwise) to increase or decrease a distance by which a tip of the set screw 257 protrudes into the first passageway 262. The set screw 257 can therefore variably adjust the area of the first passageway 262.

With continued reference to FIG. 10, the anvil 210 also defines a second passageway 264, or a fill passageway, which communicates between the hammer chamber 258 and the anvil chamber 260. The hydraulic fluid can flow between the hammer chamber 258 and the anvil chamber 260 via the second passageway 264. The second passageway 264 also communicates with the axial through bore 246 and is selectively opened or closed by the camshaft 206, as will be discussed further herein. The first passageway 262 is narrower than the second passageway 264, and thus the flow of the hydraulic fluid is more restricted through the first passageway 262 than the second passageway 264.

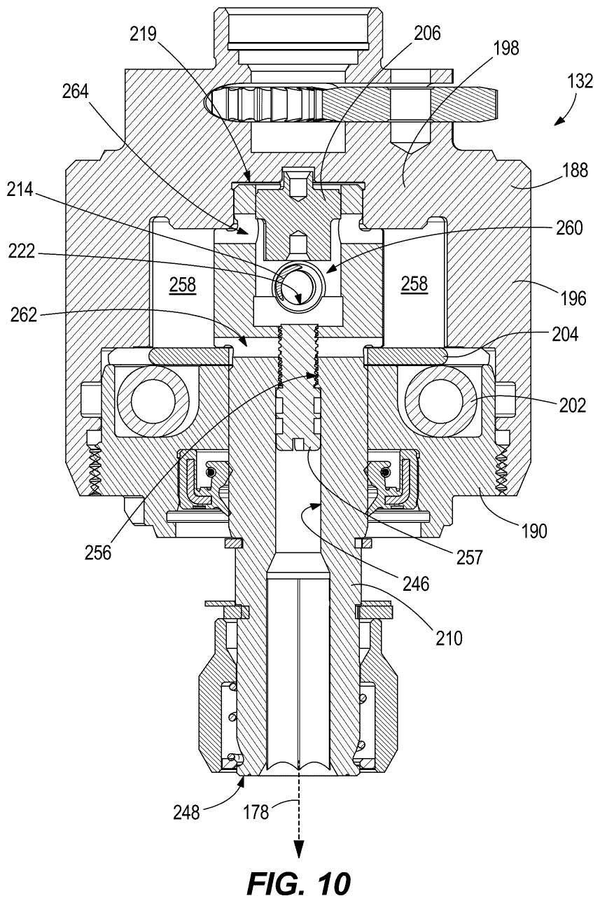

With reference to FIG. 11A, annular side wall 196 of the hammer 188 includes an inner surface 266 and a pair of lugs 268 protruding radially inward from the inner surface 266 at opposite sides thereof. The blades 212 are arranged in facing relationship with the inner surface 266. During operation of the impulse driver 100 the hammer 188 rotates relative to the anvil assembly 184 such that the lugs 268 make repeated impacts against blades 212, as will be discussed herein.

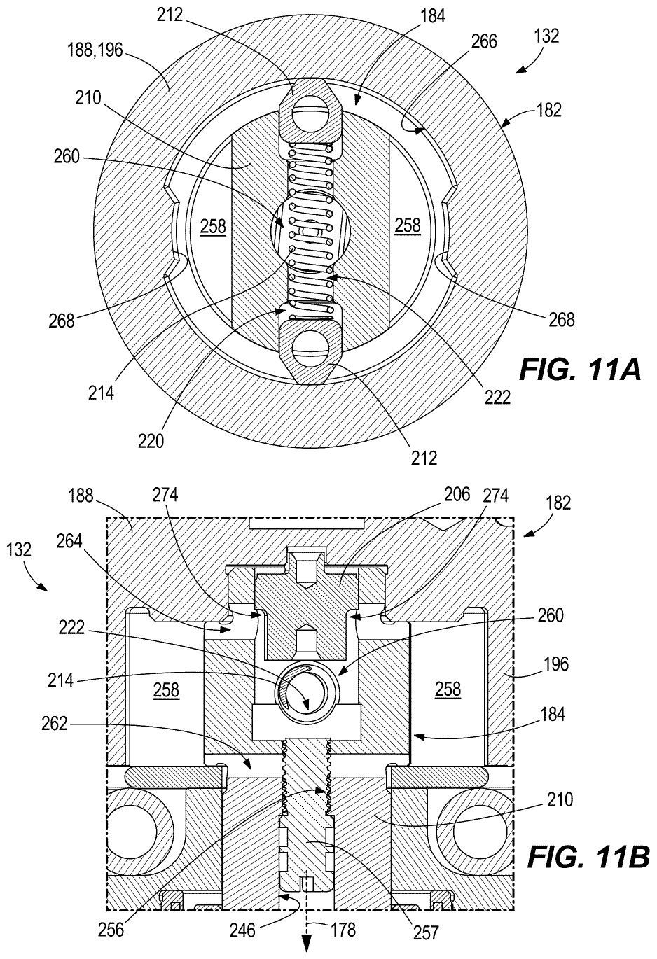

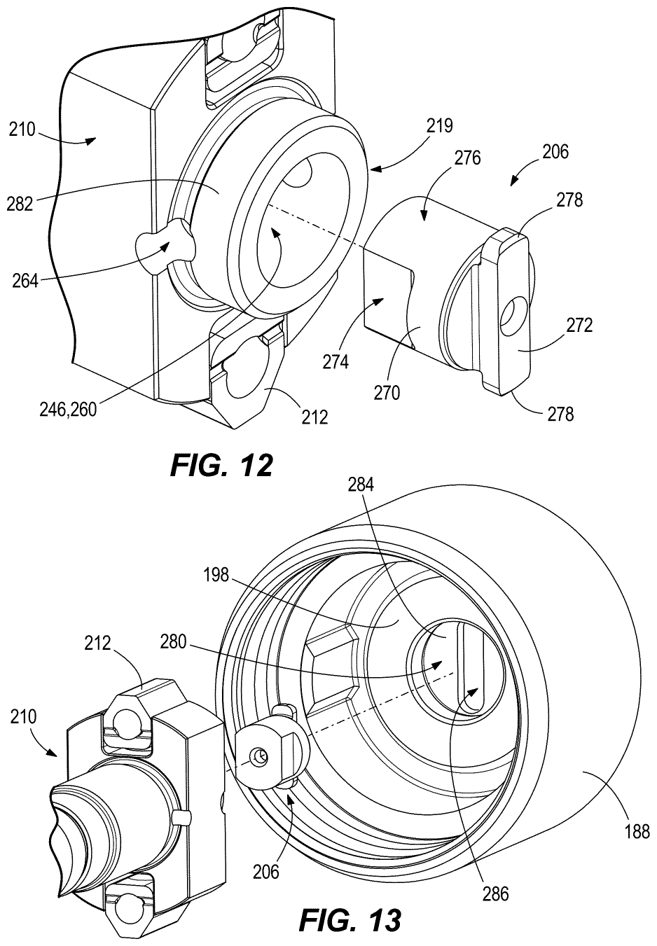

With reference to FIGS. 12 and 13, the camshaft 206 includes a body portion 270 and a key 272 which protrudes axially and radially away from the body portion 270. The body portion 270 is generally cylindrical but includes a pair of recesses or flats 274 located on opposite sides thereof. A pair of lobes 276 are formed between the pair of flats 274, such that the lobes 276 and the flats 274 alternate about a circumference of the body portion 270. The body portion 270 is received into the axial through bore 246 with the lobes 276 and the flats 274 located adjacent the second passageway 264. As the camshaft 206 rotates relative to the anvil 210, the flats 274 and the lobes 276 alternatingly close and open the second passageway 264 to permit or prevent the hydraulic fluid to flow through the second passageway 264.

In the illustrated embodiment, the key 272 is formed as a narrow, elongated rib. The key 272 includes a pair of wings or tabs 278 which protrude radially beyond a circumference of the body portion 270. The closed rear wall 198 of the hammer 188 defines a cylindrical recess 280. The rear end 219 of the anvil 210 includes a shaft segment 282 that is cylindrical and is received into the cylindrical recess 280. The cylindrical recess 280 is partially defined by a rear surface 284, and the rear surface 284 defines a receptacle 286 having a shape corresponding to the shape of the key 272. In the illustrated embodiment, the receptacle 286 is narrow and elongated to match the key 272. In other embodiments, the key 272 and the receptacle 286 can have other corresponding shapes (e.g., cross-shapes, triangular shapes, etc.). Engagement between the key 272 and the receptacle 286 rotationally couples the camshaft 206 to the hammer 188 such that the camshaft 206 rotates together with the hammer 188. The tabs 278 are captured between the closed rear wall 198 and the shaft segment 282, which fixes an axial position of the camshaft 206. The unique arrangement of the camshaft 206 with the key 272 and tabs 278 received into the receptacle 286, as described herein, enable the shaft segment 282 to directly abut the rear surface 284 of the closed rear wall 198. As such, a rearmost surface of the anvil 210 directly faces and directly abuts the rear surface 284 of the hammer 188. This provides a reduction in the axial length of the impulse assembly 132, which allows an overall length of the impulse driver 100 to be reduced.

Operation of the impulse driver 100 will now be described with reference to FIGS. 11A-11B and 14A-15B. FIGS. 11A and 11B illustrate the hammer assembly 182 oriented at a starting position relative to the anvil assembly 184. When the electric motor 128 is activated, the motor shaft 140 rotates, which causes the hammer assembly 182 to rotate as torque from the motor shaft 140 is transmitted to the hammer assembly 182 via the transmission 130. In the

starting position, the camshaft 206 is oriented with the flats 274 positioned adjacent the second passageway 264 such that the second passageway 264 is open. The hydraulic fluid is able to flow through the second passageway 264 between the hammer chamber 258 and the anvil chamber 260 in this orientation.

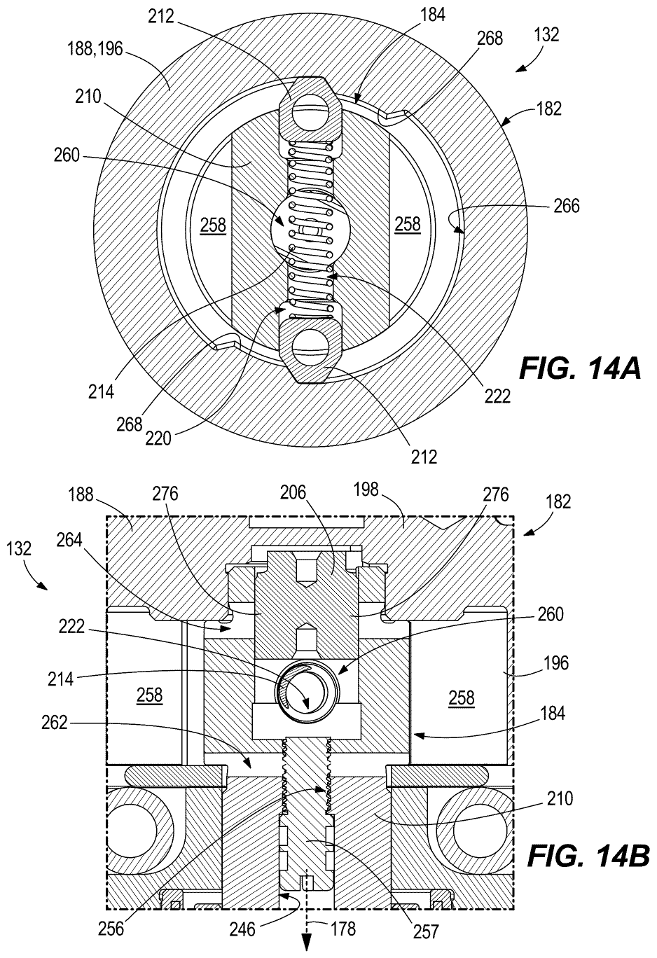

With reference to FIGS. 14A and 14B, as the hammer assembly 182 rotates relative to the anvil assembly 184 (counterclockwise from FIG. 11A to FIG. 14A), the lugs 268 approach and impact the blades 212. The impact between the lugs 268 and the blades 212 communicates torque from the hammer assembly 182 to the anvil assembly 184. The anvil assembly 184 is coupled to the output tool (e.g., the driver bit) via the tool holder 112 and transmits the torque to a working member (e.g., a fastener). As the fastener is tightened into a workpiece, it resists tightening and exerts a reactionary torque against the anvil assembly 184, causing the anvil assembly 184 to resist or cease co-rotation with the hammer assembly 182.

In the orientation shown in FIGS. 14A and 14B, the camshaft 206 is oriented with the lobes 276 positioned adjacent the second passageway 264 such that the second passageway 264 is closed by the lobes 276. The hydraulic fluid is not able to flow through the second passageway 264 between the hammer chamber 258 and the anvil chamber 260 in this orientation. However, the hydraulic fluid may still flow between the hammer chamber 258 and the anvil chamber 260 via the first passageway 262.

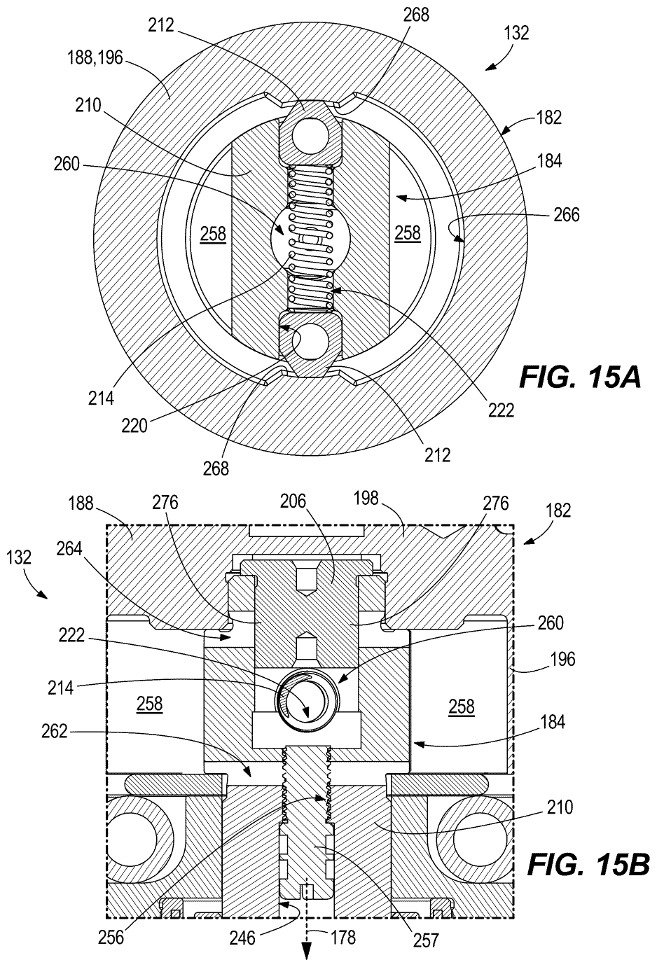

With reference to FIGS. 15A and 15B, when a sufficient reactionary torque is exerted against the anvil 210, the lugs 268 ramp up and slip over the blades 212, thereby pushing the blades 212 radially into the slots 220 against the bias of the spring 214. As the blades 212 retract into the slots 220, volume of the anvil chamber 260 is reduced, which causes a corresponding increase of the pressure of the hydraulic fluid within the anvil chamber 260. The second passageway 264 remains closed by the camshaft 206 in this position, such that the hydraulic fluid may only escape the anvil chamber 260 by flowing to the hammer chamber 258 via the first passageway 262. The smaller area of the first passageway 262 limits a flow rate of the hydraulic fluid therethrough. Thus, the blades 212 may only retract into the slots 220 at a rate governed by the flow rate of the hydraulic fluid through the first passageway 262. The hydraulic fluid may therefore slow and damp inward movement of the blades 212 and thereby increase the duration over which the lugs 268 engage the blades 212. The hydraulic fluid may also reduce noise emissions and inhibit wear on the components of the hammer assembly 182 and anvil assembly 184 throughout impact.

Eventually, the hammer assembly 182 rotates relative to the anvil assembly 184 past the position shown in FIGS. 15A and 15B and returns to a position like that shown in FIGS. 11A and 11B. The camshaft 206 again becomes oriented with the flats 274 positioned adjacent the second passageway 264 such that the second passageway 264 is open. The hydraulic fluid is able to flow through the second passageway 264 between the hammer chamber 258 and the anvil chamber 260 in this orientation. The spring 214 biases the blades 212 back out from the slots 220, which causes the volume of the anvil chamber 260 to increase. The hydraulic fluid may flow from the hammer chamber 258 back into the anvil chamber 260 via both passageways 262, 264.

Although the disclosure has been described in detail with reference to certain preferred embodiments, variations and modifications exist within the scope and spirit of one or more independent aspects of the disclosure as described. Various features and advantages of the disclosure are set forth in the following claims.

What is claimed is:

1. A power tool configured to deliver torque impulses to a tool bit, the power tool comprising:
a housing;
a motor supported within the housing; and
an impulse assembly supported within the housing and configured to be driven by the motor, the impulse assembly including an anvil assembly and a hammer assembly configured to impart a torque impulse to the anvil assembly, the impulse assembly defining a hammer chamber and an anvil chamber each filled with a hydraulic fluid;
wherein the hammer assembly includes:
a hammer defining an inner surface and a lug protruding radially from the inner surface, and
a camshaft;
wherein the anvil assembly includes:
an anvil defining a passageway communicating between the hammer chamber and the anvil chamber, and
a blade coupled to the anvil and configured to impact the lug;
wherein the camshaft is configured to selectively open and close the passageway; and
wherein the camshaft defines a key, and the hammer defines a key receptacle that receives the key to rotationally couple the camshaft to the hammer.

2. The power tool of claim 1, wherein the camshaft further includes a tab axially captured between the anvil and the hammer.

3. The power tool of claim 1, wherein the hammer defines an outer diameter, and a ratio of a rotational inertia of the hammer assembly to the outer diameter of the hammer when the motor operates at a maximum speed is between 1.0 and 2.0.

4. The power tool of claim 1, wherein the hammer assembly further includes an end cap coupled to the hammer, and wherein the power tool further comprises a wiper seal positioned between the end cap and the anvil to seal the hydraulic fluid.

5. The power tool of claim 1, further comprising:
a case defining a bearing pocket; and
a bearing having an inner race supporting the anvil and an outer race received into the bearing pocket, the outer race including a cylindrical outer wall and a flange protruding radially from the cylindrical outer wall.

6. The power tool of claim 5, wherein the bearing pocket includes a cylindrical bore and a counterbore, and wherein the cylindrical outer wall is received in the cylindrical bore, and the flange is at least partially received in the counterbore.

7. The power tool of claim 6, wherein an axial length of the outer race is equal to or greater than an axial length of the bearing pocket.

8. An impulse assembly for a power tool, the impulse assembly comprising:
a hammer assembly including a hammer and a camshaft coupled to the hammer, the hammer defining an inner surface and a lug protruding radially inward from the inner surface, and
an anvil assembly including an anvil and a blade positioned to impact the lug during rotation of the hammer;
wherein the impulse assembly defines a hammer chamber and an anvil chamber each filled with hydraulic fluid;
wherein the anvil defines a first passageway and a second passageway communicating between the hammer chamber and the anvil chamber;
wherein the camshaft is configured to selectively open and close the second passageway; and
wherein the camshaft includes a tab axially captured between the anvil and the hammer.

9. The impulse assembly of claim 8, wherein the anvil includes a set screw configured to adjust a cross-sectional area of the first passageway.

10. The impulse assembly of claim 8, further comprising a bladder positioned within the hammer assembly and configured to modulate pressure of the hydraulic fluid.

11. The impulse assembly of claim 10, further comprising a friction plate positioned adjacent the bladder and defining notches communicating with the hammer chamber.

12. The impulse assembly of claim 8, wherein the camshaft includes lobes and flats alternating about a circumference of the camshaft to selectively open and close the second passageway.

13. The impulse assembly of claim 8, wherein the tab is captured between a rear wall of the hammer and a shaft segment of the anvil.

14. The impulse assembly of claim 8, wherein the camshaft defines a key, and the hammer defines a key receptacle that receives the key to rotationally couple the camshaft to the hammer.

15. A power tool comprising:
a housing;
a motor supported within the housing;
an output assembly configured to be driven by the motor, the output assembly including an output shaft and a tool holder configured to support a tool bit;
a case defining a bearing pocket including a cylindrical bore and a counterbore; and
a bearing having an inner race supporting the output shaft and an outer race received into the bearing pocket, the outer race including a cylindrical outer wall and a flange protruding radially from the cylindrical outer wall;
wherein the cylindrical outer wall is received in the cylindrical bore, and the flange is at least partially received in the counterbore.

16. The power tool of claim 15, wherein the flange abuts a stop surface of the counterbore.

17. The power tool of claim 15, wherein the outer race has an axial length equal to or greater than an axial length of the bearing pocket.

18. The power tool of claim 15, wherein the bearing is insert molded into a molded case and includes two flanges and a circumferential groove between the two flanges.

19. The power tool of claim 15, wherein the output assembly further comprises:
a hammer assembly including a hammer and a camshaft coupled to the hammer, the hammer defining an inner surface and a lug protruding radially inward from the inner surface; and
an anvil assembly including an anvil and a blade positioned to impact the lug during rotation of the hammer;
wherein the camshaft defines a key, and the hammer defines a key receptacle that receives the key to rotationally couple the camshaft to the hammer.

20. The power tool of claim 19, wherein the hammer defines an outer diameter, and a ratio of a rotational inertia of the hammer assembly to the outer diameter of the hammer when the motor operates at a maximum speed is between 1.0 and 2.0.
